(19) United States
(12) Patent Application Publication
(10) Pub. No.: US 2024/0331485 A1
(43) Pub. Date: Oct. 3, 2024

(54) MEDIA CASSETTE MEDIA DESTRUCTION

(71) Applicant: NCR Atleos Corporation, Atlanta, GA (US)

(72) Inventors: Steven James Birnie, Dundee (GB); Ian McFarlane Denny, Perth (GB)

(21) Appl. No.: 18/129,187

(22) Filed: Mar. 31, 2023

(51) Int. Cl. G07D 11/26; G07D 11/125; G07D 11/225

(52) U.S. Cl. CPC G07D 11/26; G07D 11/125; G07D 11/225; G07D 2211/00

(57) ABSTRACT

A security breach is detected on a media terminal, media recycler/dispenser, safe, and/or media cassette. A note destruction apparatus of the media cassette is activated causing the notes in the cassette to be burned, ripped, cut, sliced, and/or tom. The destroyed notes are unfit for use after activation of the note destruction apparatus of the media cassette.

### BACKGROUND

The principals of safe construction have not changed since the 16^{th} century. The current industry standard way of securing cash is to surround the safe in a combination of steel plate and concrete. There are variations to this, using ½″ thick steel plate with thicker layers of concrete and metal additives. Access doors are secured by a series of steel bolts.

Thus still today, safes are costly, not environmentally friendly, component parts are not reusable, made of heavy materials, and difficult to transport and install. Similarly, when a breach is detected within a cassette of the safe, standard approaches are used to attempt to destruct the notes, such as staining the notes with indelible ink, blasting the notes, etc. Unfortunately, these note destruction technologies fail to ensure that all of the notes are damaged to a point that they are unusable by a thief. Consequently, the thief is often able to obtain a decent amount of usable notes following a breach.

### SUMMARY

In various embodiments, a media recycler/dispenser, a media cassette, and method for destroying media notes in a media cassette upon a breach are presented. In an embodiment, a media recycler/dispenser is provided. A note destruction apparatus is integrated into a media cassette of a media recycler/dispenser. When a breach is detected by security agents/systems associated with the recycler/dispenser and/or media cassette, the note destruction apparatus is activated to burn, rip, tear, cut, slice, and/or serrate the notes within the cassette making the notes of the cassette following the breach unfit for use. Each note in the cassette is destroyed when a breach is detected.

### BRIEF DESCRIPTION OF THE DRAWINGS

FIG. 1A is a diagram of a system for destroying notes of a media cassette, according to an example embodiment.

FIG. 1B is a diagram of a non-breach state of a media cassette with an integrated note destruction apparatus, according to an example embodiment.

FIG. 1C is a diagram of a breach-state of a media cassette with an integrated note destruction apparatus, according to an example embodiment.

FIG. 1D is a diagram of a non-breach-state of a media cassette with a different integrated note destruction apparatus from that which is depicted in FIGS. 1B and 1C, according to an example embodiment.

FIG. 1E is a diagram of a breach state of a media cassette with the integrated note destruction apparatus presented in FIG. 1D, according to an example embodiment.

FIG. 1F is a diagram of a non-breach-state of a media cassette with a different integrated note destruction apparatus from that which is depicted in FIGS. 1B-1D, according to an example embodiment.

FIG. 1G is a diagram of a breach state of a media cassette with the integrated note destruction apparatus presented in FIG. 1F, according to an example embodiment.

FIG. 2 is a flow diagram of a method for destroying media notes in a media cassette upon a breach, according to an example embodiment.

### DETAILED DESCRIPTION

Safe designs in the industry are focused on structural strength and increased difficulty for any would be intruder. Safes are common in media terminals, such as automated teller machines, self-service terminals, and/or point-of-sale terminals. Businesses that provide media terminals incur substantial labor and costs associated with obtaining, installing, and monitoring the terminals. Security of media terminals are of the upmost concern of the businesses since the terminals house currency in their safes.

A Media terminal includes a media peripheral device that interfaces to the terminal to permit currency-based transactions. The media peripheral device can be a recycler or a dispenser. For purposes of the discussions herein both the recycler and dispenser are also a media depositor, which is capable of accepting currency as a payment for a transaction or as a deposit into a financial account. The recycler/dispenser includes media cassettes into which the currency is deposited, recycled, and dispensed. In most/all cases, the cassettes are located within a safe of the recycler/dispenser.

When breaches are detected into the recyclers/dispensers, safes, and/or cassettes, current technologies attempt to activate mechanisms to destroy the notes in the cassettes to prevent thieves from being able to use the notes should the thieves successfully breach the cassettes. Current approaches attempt to coat the notes within the cassettes with indelible ink or other destructive fluids. None of these approaches ensure that all the notes of the cassettes are destroyed beyond a point of being useful to thieves. Thus, even when thieves are aware of the security measures, they still attempt to gain access to the cassettes because some notes are still likely usable by the thieves.

These problems are solved with the teachings provided herein and below. A media cassette is equipped with a note destruction apparatus that is activated by the media terminal or recycler/depositor upon detection of a security breach. The note destruction apparatus ensures that all of the notes are destroyed such that none of the notes in the cassette are usable by thieves.

As used herein and below, the phrases associated note destruction or “destroying the notes” is intended to mean that each note of a given media cassette is substantially damaged to a point that none of the notes in the cassette are fit for use in commerce. The notes can be destroyed through burning through the centers of the notes, cutting through the notes, serrating through the notes, slicing the notes in half, ripping the notes in half, destroying serial numbers on the notes, and/or combinations of these things.

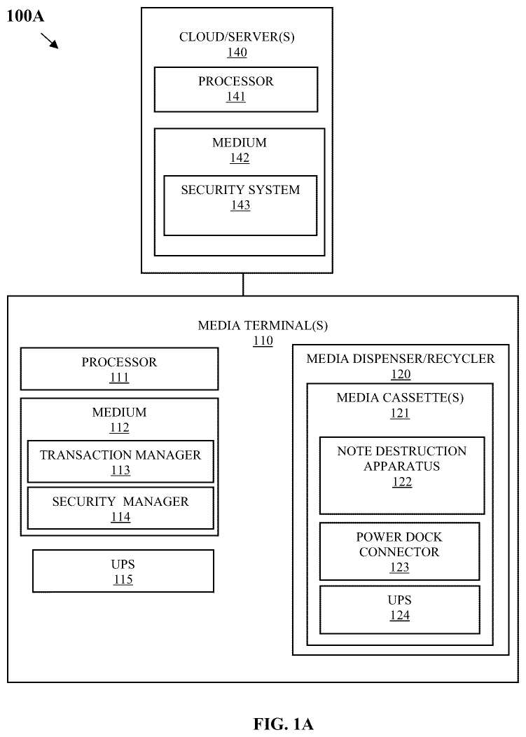

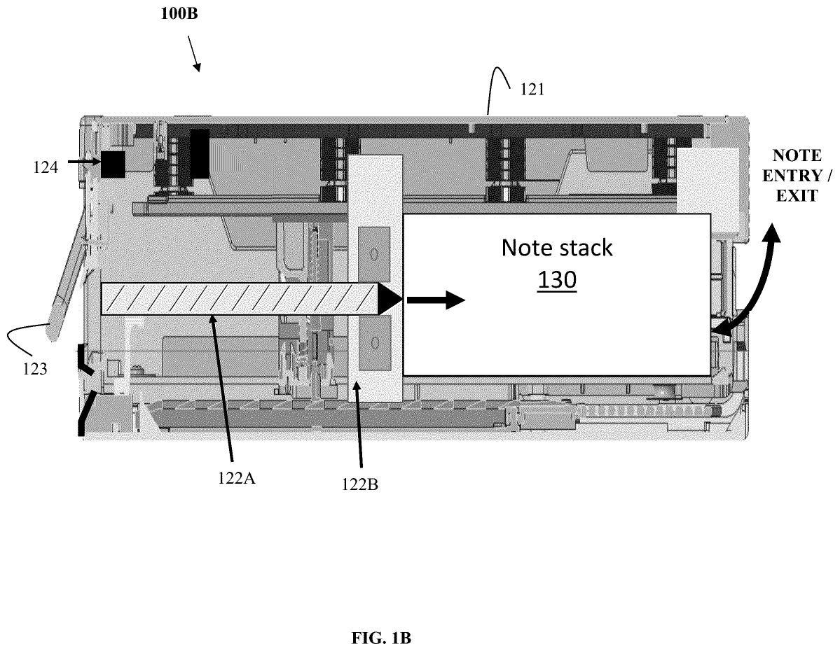

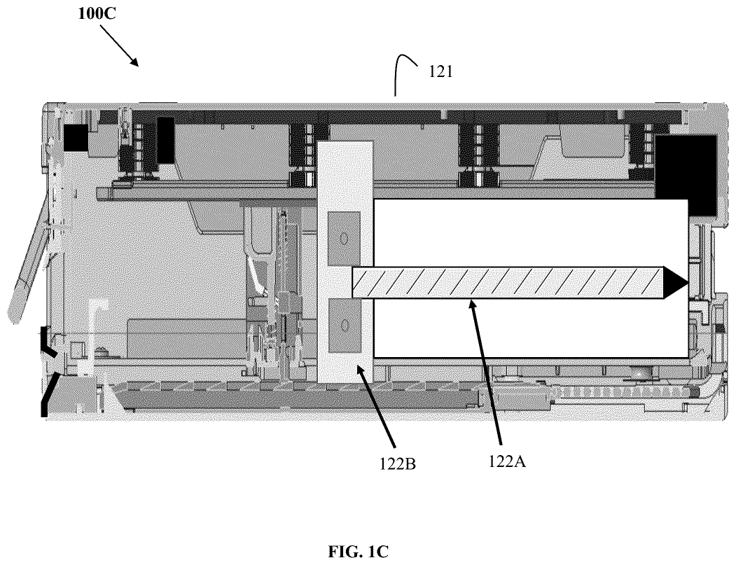

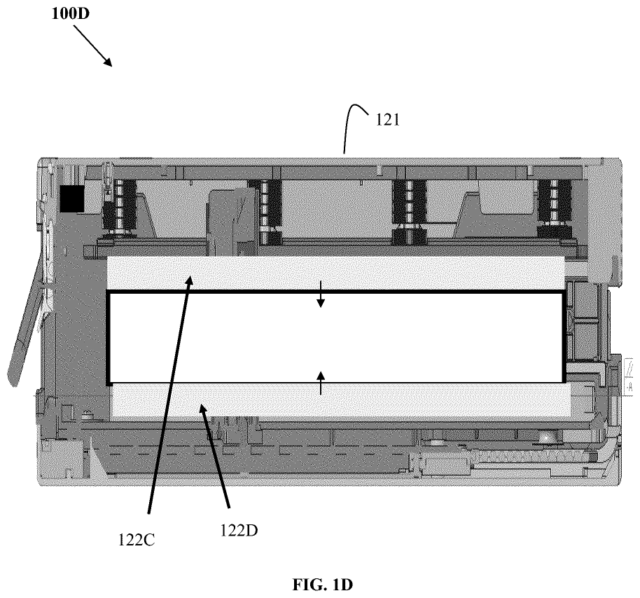

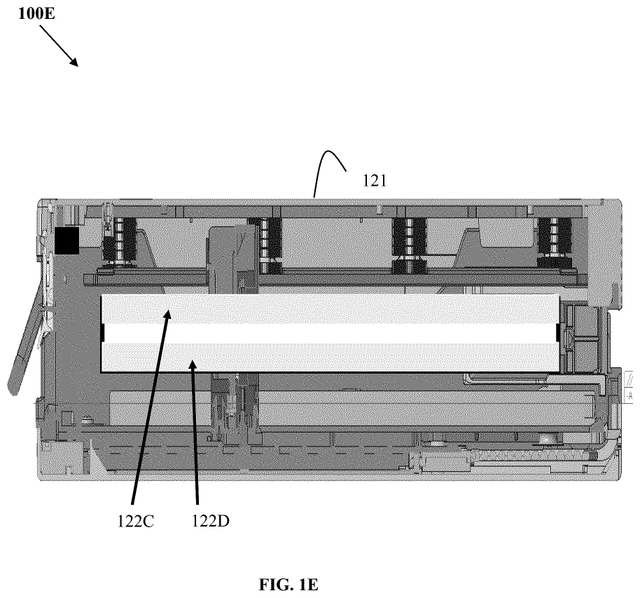

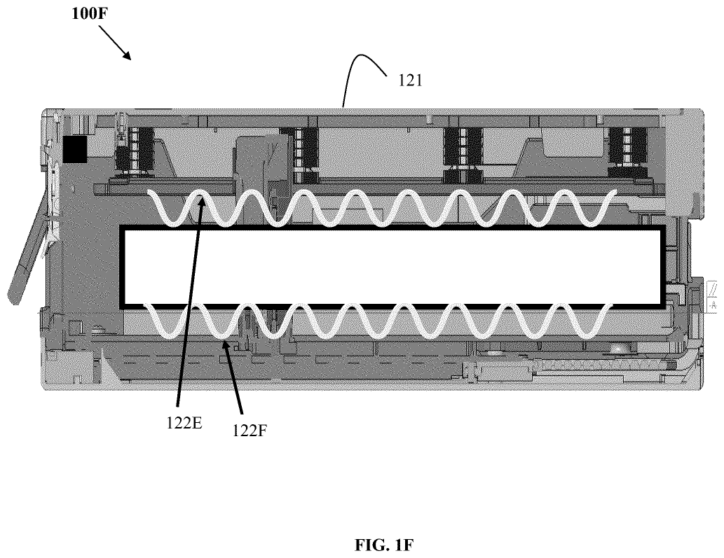

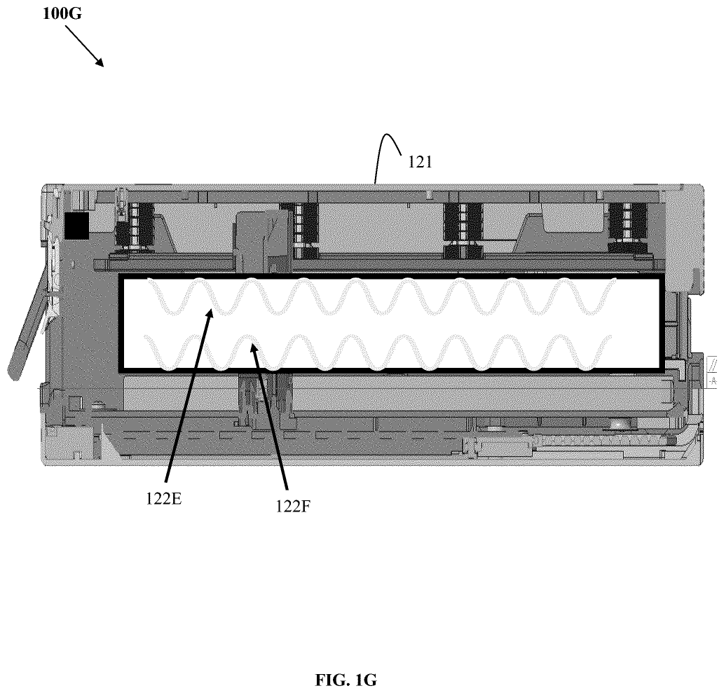

FIG. 1A is a diagram of a system 100A for destroying notes of a media cassette upon detection of a security breach. It is to be noted that the components are shown schematically in greatly simplified form, with only those components relevant to understanding of the embodiments being illustrated.

Furthermore, the various components (that are identified in FIG. 1A) are illustrated and the arrangement of the components is presented for purposes of illustration only. It is noted that other arrangements with more or less components are possible without departing from the teachings of destroying notes of a media cassette upon detection of a security breach presented herein and below.

System 100A includes one or more media terminals (hereinafter “terminals”) 110 and optionally a cloud 140 or a server 140 (hereinafter just “cloud 140’). Each terminal 110 includes a processor 111, a non-transitory computer-readable storage medium (hereinafter just “medium”) 112, which includes executable instructions for a transaction manager 113 and a security manager 114. The instructions when executed by processor 111 from memory 112 cause the processor 111 to perform the operations discussed herein and below for 113-114. Each terminal 110 further includes a media dispenser/recycler 120 and optionally an uninterrupted power supply (UPS) 115.

Media dispenser/recycler 120 includes media cassettes 121 within a safe module of 120. Each cassette 121 include storage for notes (e.g., cash), a note destruction apparatus 122, a power dock connector 123, and optionally an UPS. Media dispenser/recycler 120 includes a variety of other modules that are not relevant to understanding and comprehending the teachings presented herein; for example, a dispense/deposit module, a note validator module, an upper transport module, a lower transport module, and escrow module, a media deskew module, and other modules.

Cloud 140 includes at least one processor 141 and medium 142, which includes executable instructions for a security system 143. The processor 141 when executed by processor 141 cause processor 142 to perform operations discussed herein and below for 143.

The conventional design, componentry, and capabilities of existing cassettes are enhanced with the note destruction apparatuses 122 presented herein to provide cassettes 121 that ensure complete destruction of notes stored in the cassettes 121.

Each cassette 121 includes a power dock connector 123 that permits the corresponding note destruction apparatus 122 to receive power for its electromechanical components. Each apparatus 122 is integrated into an interior of the corresponding cassette 121. In an embodiment, the power dock connector 123 is located along a top rear edge of the cassette 121. This permits the power dock connector 123 and other existing, if any, electromechanical components of the cassette 121 to receive power from alternating current and/or UPS 115 supplied by the media terminal 110 and/or the dispenser/recycler 120.

Electromechanical control of the apparatus 122 is achieved through internal motors of the cassette 121 which are activated and supply power to the apparatus when a security breach is detected by dispenser/recycler 120 and/or terminal 110. The power causes a component of apparatus 122 to be heated and the motors drive a single component through a center of the notes in the cassette 121 or drive one or two components from a top and a bottom of the notes down into a center of the notes.

In an embodiment, the apparatus 122 includes a single component and a pusher plate. The pusher plate drives the component through a center of the notes in the cassette 121. In an embodiment, the single component is a pointed bolt, a wire, or other sharp metal-based object capable of being heated without melting. The single component is initially configured in a non-breach state for the cassette 121 so that one end of the component is interfaced between two pushing elements of the pusher plate and the corresponding end of the single component is located behind a first note in the bunch of notes stored in the cassette 121. When a breach state is detected, the internal motors heat the single component and drive the pusher plate, which pulls the single component on the interfaced end forward through the first note and a center of the bunch of notes until it is locked in place by the pusher plate when the trailing edge of the single component is between the two pushing elements. A length of the single component is substantially equal to a length of a note capacity area of the cassette 121. For example, if the available note capacity area is 24 inches, length of the single component is slightly more than 24 inches, such as 25 inches or 24.1 inches.

In an embodiment, the apparatus 122 includes two components. A first component is located above the area that stores the notes and is the length of the note capacity area of the cassette 121. A second component is located below the area that stores the notes and is the same length as the first component and corresponds to the note capacity area of the cassette 121. In a non-breach state the first component is above the notes in the cassette 121 and the second component is below the notes in the cassette 121. In a breach state, power is supplied to heat the two components and the first component is forced downward in the direction of the second component and into the notes while simultaneously the second component is forced upwards in the direction of the first component and into the notes. In an embodiment, the apparatus with two components includes a blade, a knife, or a serrated blade/knife.

FIGS. 1B and 1C illustrate a single component apparatus 122 with a pusher plate, according to an embodiment. FIG. 1B illustrates a non-breach state of the apparatus 122 during which the single component 122A is against or adjacent to a back side wall of the cassette 121 and a leading edge of the single component is held between to pushing elements of the pusher plate 122B. A state of notes 130 are illustrated and the note entry and exist into the cassette 121 is illustrated.

FIG. 1C illustrates a breach state for the single component apparatus 122. Pusher plate 122B urges a heated single component 122A from its interfaced leading edge to its trailing edge forward through a substantial center of the notes 130 until the single component 122A has when the distance or length of the note capacity area ensuring that each of the notes 130 were destroyed. The two pushing elements of the pusher plate 122B lock the trailing edge into place. Thus, making it incredibly difficult for any thief that breached the cassette 121 to remove the notes 130. FIG. 1C illustrates a final condition or state of the notes 130 and the cassette 121 after the apparatus 122 is activated from a breach detection and has completely pushed single component 122A through the notes 130.

FIGS. 1D and 1E illustrate a two-component apparatus, 122, according to an example embodiment. FIG. 1D illustrates a non-breach state during which the first component 122C is oriented and situated above a top surface of the notes 130 within the cassette 121 and during which the second component is oriented and situated below a bottom surface of the notes 130 within the cassette 121.

FIG. 1E illustrates a breach state or final condition following breach detecting and breach activation for apparatus 122 for the notes 130 and the cassette 121. Simultaneously heated components 122C and 122D are driven or urged towards one another to a center of the notes 130. The notes 130 are burned, cut, ripped, and serrated such that the notes 130 are no longer usable by any thief that gains access to the cassette 121.

FIGS. 1F and 1G illustrate a two-component apparatus 122 that utilizes a serrated blade. FIG. 1F illustrates the non-breach state with first component 123 situated and located above a top surface of the notes 130 within the cassette 121 and with second component 123 situated and located below a bottom surface of the notes 130 within the cassette 121.

FIG. 1G illustrates a breach state of final condition following breach detection and breach activation of apparatus 122 for the notes 130 and the cassette 121. Simultaneously heated serrated 122E and 122F are driven or urged towards one another to a center of the notes 130. The notes 130 are burned, cut, ripped and serrated such that the notes 130 are no longer usable by any thief that gains access to cassette 121.

In an embodiment, cassette 121 includes its own UPS 124 such that when AC power is lost, the UPS 124 continues to provide power to the internal motors and the components 122A-122F of an apparatus 122. A sensor can activate within the cassette 121 when the cassette 121 is removed from the safe without authorization. For example, the sensor is deactivated for authorized access but for unauthorized access the sensor is activated. When the sensor is active and the cassette 121 is removed from the safe, this causes the components 122A-122F to receive power from the UPS 124 and activate the motors causing components 122A-112F to destroy the notes 130 within the cassette 121. This provides an additional level of security for the cassette 121 and the notes 130 should somehow no security alert was raised by dispenser/recycler 120 or by terminal 110. The sensor can be included outside the cassette 121 on a rack mechanism for the cassette 121 or can be included within the cassette 121 on a top cover of the cassette 121.

In an embodiment, single component 122A is a rod, a wire, a blade, a knife, a bolt, a screw, or another other component capable of being heated and with a shape to force through notes 130. In an embodiment components 122C-122F are any combination of rods, blades, knifes, serrated blades, capable of being heated and forced into a center of notes 130.

In an embodiment, terminal 110 is an automated teller machine (ATM), a self-service terminal (SST), or a point-of-sale (POS) terminal. In an embodiment, transaction manager 113 process transaction on the terminal 110 for financial or retail-based transactions.

In an embodiment, security manager 114 detects based on sensors and security software when there is a breach on a safe associated with cassettes 121 or on the cassettes 121 and sends and instruction that causes power to be supplied to the cassettes 121 to activate the motors of the cassettes 121, the heating, and the operations discussed above for the apparatuses 122. In an embodiment, a security manager 114 reports the breach to a security system 143 in the cloud 140. Security system 143 initiates security actions (e.g., video footage review, personnel/staff notifications, etc.) for the store associated with terminal 110 and dispatches authorities to a location associated with terminal 110.

In an embodiment, security software of dispenser/recycler 120 detects a breach event and causes power to be supplied to the cassettes 121 that causes power to be supplied to the cassettes 121 to activate the motors of the cassettes 121, the heating, and the operations discussed above for the apparatuses 122. The security software of dispenser/recycler 120 notifies security manager 114 and security manager 114 notifies security system 143.

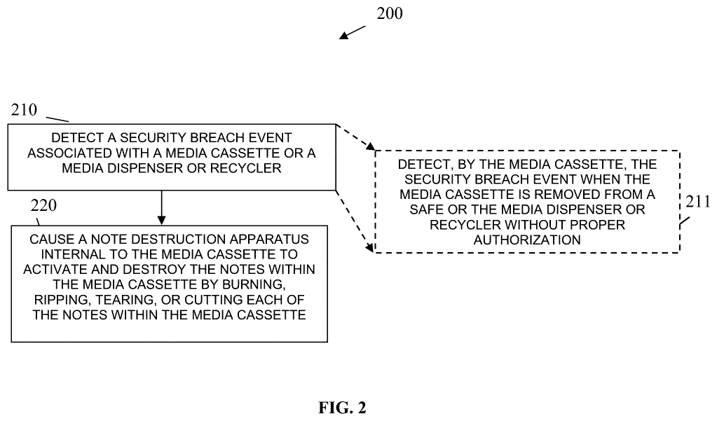

The above-referenced embodiments and other embodiments will now be discussed with reference to FIG. 2. FIGS. is a flow diagram of a method 200 for destroying media notes in a media cassette upon a breach, according to an example embodiment. The software module(s) that implements the method 200 is referred to as a “cassette note destroyer.” The cassette note destroyer is implemented as executable instructions programmed and residing within memory and/or a non-transitory computer-readable (processor-readable) storage medium and executed by one or more processors of one or more devices. The processor(s) of the device(s) that executes the cassette note destroyer are specifically configured and programmed to process cassette note destroyer. The cassette note destroyer can or cannot have access to one or more network connections during its processing. Any connections can be wired, wireless, or a combination thereof.

In an embodiment, the device that executes the cassette note destroyer is media terminal 110. In an embodiment, terminal 110 is an ATM, an SST, or a POS terminal. In an embodiment, the device that executes the cassette note destroyer is media cassette 121. In an embodiment, the device that executes the cassette note destroyer is the media recycler or dispenser 120. In an embodiment, the cassette note destroyer is executed on a combination of different devices 110 and/or 120. In an embodiment, the cassette note destroyer is 114.

At 210, the cassette note destroyer detects a security breach event associated with a media cassette 121 or a media dispenser or recycler 120. The security breach event can be generated and raised by a variety of security systems and software executing on one or more devices 110, 120, and/or 121.

In an embodiment, at 211, the cassette note destroyer detects the security breach event when the media cassette 120 is removed from a safe of the media dispenser or recycler 120 without proper authorization. This can be achieved via as sensor that is deactivated when proper authorization is received to remove the media cassette 120 but is active when authorization is not obtained. The sensor is located within the media dispenser or recycler 120 or is located within the media cassette 121.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A media recycler or dispenser, comprising:
at least one media cassette to store notes;
wherein the at least one media cassette comprises:
a note destruction apparatus comprising at least one heated element that when activated is driven through or into the notes and destroys the notes.

2. The media recycler or dispenser of claim 1, wherein the note destruction apparatus comprises a single element and a pusher plate that urges the pusher plate through a substantial center of the notes within the at least one media cassette.

3. The media recycler or dispenser of claim 2, wherein the single element is a metal rod, screw, nail, or wire.

4. The media recycler of dispenser of claim 3, wherein the single element is at least a length of a note capacity area of the at least one media cassette.

5. The media recycler or dispenser of claim 4, wherein the pusher plate locks the single element into place when the length of the note capacity area is reached preventing the notes from being removed from the at least one media cassette without destruction of the notes.

6. The media recycler or dispenser of claim 1, wherein the note destruction apparatus comprises a first element and a second element, wherein the first element is urged down from a top of the notes toward a center of the notes while the second element is urged up from a bottom of the notes toward the center of the notes.

7. The media recycler or dispenser of claim 6, wherein the first and second elements comprise a metal blade, knife, or serrated blade.

8. The media recycler or dispenser of claim 1, wherein the at least one media cassette further includes an uninterrupted power supply to supply power to motors and heaters associated with the note destruction apparatus when external power is lost to a host media terminal associated with the media recycler of dispenser.

9. The media recycler or dispenser of claim 1, wherein the at least one media recycler or dispenser is a peripheral device of an automated teller machine, a self-service terminal, or a point-of-sale terminal.

10. The media recycler or dispenser of claim 1, wherein the media recycler or dispenser is a peripheral device of an automated teller machine, a self-service terminal, or a point-of-sale terminal.

11. A note destruction apparatus, comprising:
at least one element; and
a motor associated with a media cassette to urge the at least one element;
wherein the at least one element is located within the media cassette;
wherein the motor is adapted to drive or to urge the at least one element into notes stored in the media cassette to destroy the notes.

12. The note destruction apparatus of claim 11, wherein the at least one element is a single heated element and wherein the note destruction apparatus further comprises a pusher plate adapted to hold the single heated element on a leading edge against a surface associated with a first note within the media cassette, urge the single heated element through a center of the notes, and lock a trailing edge of the single heated element within the pusher plate.

13. The note destruction apparatus of claim 12, wherein the single heated element is a metal rod, screw, nail, or wire.

14. The note destruction apparatus of claim 11, wherein the at least one element is a first element and a second element, wherein the first element is located above a top surface of the notes within the media cassette and adapted to be driven down towards a center of the notes while the second element is located below a bottom surface of the notes within the media cassette and adapted to be driven up towards the center of the notes.

15. The note destruction apparatus of claim 14, wherein the first and second elements lock in place when reaching a substantial center of the notes preventing the notes from being removed from the media cassette

16. The note destruction apparatus of claim 15, wherein the first and second elements comprise a metal blade, knife, or serrated blade.

17. The note destruction apparatus of claim 16, wherein the first and second elements are heated elements.

18. The note destruction apparatus of claim 11, wherein the at least one element is adapted to be heated and further adapted to burn and cut through the notes.

19. A method, comprising:
detecting a security breach event associated with a media cassette or a media dispenser or recycler;
causing a note destruction apparatus internal to the media cassette to activate and destroy notes within the media cassette by burning, ripping, tearing, or cutting each of the notes within the media cassette.

20. The method of claim 19, wherein detecting further includes detecting, by the media cassette, the security breach when the media cassette is removed from a safe or the media dispenser or recycler without prior authorization.
